(19) United States
(12) Patent Application Publication
(10) Pub. No.: US 2020/0052339 A1
(43) Pub. Date: Feb. 13, 2020

(54) Method of forming an energy storage

(71) Applicant: VON ARDENNE Asset GmbH & Co. KG, Dresden (DE)

(72) Inventors: Maik Vieluf, Moritzburg (DE); Markus Piwko, Dresden (DE)

(21) Appl. No.: 16/533,801

(22) Filed: Aug. 7, 2019

(30) Foreign Application Priority Data
Aug. 8, 2018 (DE) 10 2018 006 255.5
Nov. 16, 2018 (DE) 10 2018 128 901.4
Nov. 16, 2018 (DE) 10 2018 128 902.2

(51) Int. Cl. H01M 10/0569; H01M 10/0525; H01M 4/66; H01M 4/70

(52) U.S. Cl. CPC H01M 10/0569; H01M 10/0525; H01M 2004/027; H01M 4/70; H01M 4/661

(57) ABSTRACT

In various embodiments, a method of forming an energy storage may be provided, said energy storage having: an anode and a cathode, said anode having: an active anode material having a first chemical potential; said cathode having: a foil including aluminum; an active cathode material including lithium, wherein the active cathode material has a second chemical potential different than the first chemical potential; a protective material which is formed from the gas phase and separates the active cathode material from the foil in a fluid-tight manner, said method comprising: coating the foil with a mixture including the active cathode material and a protic solvent; extracting the solvent from the mixture with which the foil has been coated to form a solid layer including the active cathode material.

### CROSS-CITING TO RELATED APPLICATIONS

This application claims priority to German Applications 10 2018 128 902.2 and 10 2018 128 901.4, which were filed on Nov. 16, 2018, and to German Application 10 2018 006 255.5, which was filed on Aug. 08, 2018, the entirety of each of which is incorporated herein fully by reference.

### TECHNICAL FIELD

The disclosure relates to a method.

### BACKGROUND

Materials or components that are used in an energy storage (for example an accumulator) and are used, for example, for contact connection or for conduction of the electrical current may be exposed to the risk of chemical attack by the application of the active material from suspension. The more reactive the suspension, the higher this risk. In the case of a particularly aggressive suspension, for example an alkali, it may no longer be the case that all materials are directly suitable.

A conventional lithium ion battery (LIB) consists, for example, of two different active electrode material layers each having different active materials (from active anode material and active cathode material). The active electrode material layers have each been applied to a current collector and are separated from one another by a separator, and have been assembled facing one another with a (solid or liquid) electrolyte that fills the porosity in a cell.

LIB active electrode material layers are conventionally produced from what is called a slip (also referred to as slurry), i.e. from the liquid phase. To form the slurry, the solid constituents of the active electrode material layer (active material, binder, conductive additives, etc.) are mixed together with a solvent and this is then applied to a substrate that functions as current collector in the cell. The solvent then has to be discharged from (evaporated out of) the slip applied to the current collector again by means of what are called drying zones, such that it cures.

However, solvents usable to form the slurry are very restricted owing to a multitude of demands associated with the formation of the LIB electrode. Thus, the solvent should typically be inert toward (i.e. not chemically alter) the constituents of the electrode and the substrate, and the binder used should have good solubility therein, should ideally have a high vapor pressure and a low boiling point (for rapid evaporation), and should prevent agglomeration and sedimentation of the solid electrode constituents in the slurry, and enable good wetting on hydrophobic metallic substrates.

Owing to these demands, especially for the production of an LIB cathode from a lithium-containing active material, aprotic N-methyl-2-pyrrolidone (NMP) is conventionally used as solvent. By contrast, other solvents that do not prevent, for example, the leaching-out of lithium ions, for example protic solvents, are avoided.

### SUMMARY

In various embodiments, it has been recognized that NMP has high toxicity and reproductive toxicity and suspected carcinogenicity, releases inflammable gases and causes high costs in procurement and use, for example owing to a complex manufacturing environment that enables the processing of NMP, for instance a low-water manufacturing environment, air extraction in the drying zone and/or recovery of the evaporated NMP, etc.

In an illustrative manner, in various embodiments, a substitution of NMP is provided, for example for water or an alcohol. This likewise provides an alternative for entirely dry production of LIB electrodes, which is costly and gives poorer results. If NMP or water is processed as solvent, in various embodiments, it is possible to dispense with a low-water manufacturing environment.

In this connection, it has been recognized that, for example, it is difficult to use water or alcohol as solvent for the slip for production of an LIB electrode owing to the leaching-out (specifically for the cathode, the washing-out of lithium) of the active material and to the corrosion of the substrate, for example an aluminum foil. In addition, water and alcohol, by contrast with NMP, are a protic solvent, and so there may be the risk that the active material particles will tend to agglomerate after mixing and the wetting of the slip on a hydrophobic metallic current collector foil will be worsened.

Aluminum does form a native oxide layer. However, the effect of the use of water and/or alcohol is that constituents of the active material (e.g. lithium) may transfer into the water, and then it becomes alkaline. The alkaline liquid phase thus formed attacks the native oxide layer over and above a pH of about >8.5, and after it fails the alkaline water reacts with the metallic aluminum and hence corrodes the aluminum. Corrosion may proceed according to the following expressions:

Al₂O₃+2OH⁻+3H₂O->2 [Al (OH)₄]⁻

2Al+2OH⁻+6H₂O->2 [Al (OH)₄]⁻+3H₂

The [Al (OH)₄]⁻reaction product is soluble in water, meaning that the native oxide layer or the aluminum progressively reacts further with the water, and the reaction products formed dissolve therein, which is seen to drive corrosion further.

Illustratively, it has been recognized in various embodiments that a protective layer having higher chemical resistance to an alkaline environment than the native oxide of aluminum (e.g. aluminum oxide) facilitates the use of water and/or alcohol. The aluminum foil provided with the protective layer, illustratively, is less reactive compared to the alkaline liquid phase, and so it may be used as current collector in an energy cell (e.g. a high-energy cell) without corroding too quickly.

In various embodiments, a method of forming an energy storage may be provided, said energy storage having: an anode and a cathode, said anode having: an active anode material (e.g. electrochemically active anode material) having a first chemical potential, an optional foil including copper, for example, and/or coated with the active anode material; said cathode having: a foil including aluminum; an active cathode material (e.g. electrochemically active cathode material) including lithium (also referred to as lithium-containing active cathode material), wherein the active cathode material has a second electrochemical potential different than the first chemical potential; a protective material which is formed from the gas phase and separates the active cathode material from the foil in a fluid-tight manner, said method including: coating the foil with a mixture including the active cathode material and a protic solvent; extracting the solvent from the mixture with which the foil has been coated to form a solid layer including the active cathode material.

In various embodiments, reference is made hereinafter for simpler understanding to the active cathode material (also referred as to cathode-active material) and the active anode material (also referred as to anode-active material). The active cathode material may optionally have been provided or be provided as a layer or coating (or as a portion thereof) (also referred to as active cathode material layer). Alternatively or additionally, active anode material may have been provided or be provided as a layer or coating (or as a portion thereof) (also referred to as active anode material layer). The respective active anode/cathode material layer may include the appropriate active anode/cathode material and optionally a binder and/or optionally one or more than one conductive additive.

The descriptions given hereinafter for the active anode material may be applicable in analogy to the active anode material layer, and the descriptions given for the active cathode material may be applicable in analogy to the active cathode material layer.

For example, the method of forming an energy storage may be provided, said energy storage having: an anode and a cathode, said anode having: an active anode material layer having a first chemical potential, an optional foil including copper, for example, and/or coated with the active anode material; said cathode having: a foil including aluminum; an active cathode material layer including a lithium-containing active cathode material, wherein the active cathode material layer has a second chemical potential different than the first chemical potential; a protective material which is formed from the gas phase and separates the active cathode material layer from the foil in a fluid-tight manner, said method including: coating the foil with a mixture including the active cathode material and a protic solvent, and optionally a binder and/or optionally one or more than one conductive additive; extracting the solvent from the mixture with which the foil has been coated to form a solid layer including the active cathode material.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiment. In the following description, various embodiments are described with reference to the following drawings, in which

FIGS. 1A and 1B each show a method according to various embodiments in a schematic flow diagram; and

FIGS. 2, 3 and 4 each show an energy storage in various embodiments in a schematic side view and a schematic cross-sectional view; and

FIGS. 5 and 6 each show an energy storage in various embodiments in a schematic side view and a schematic cross-sectional view.

### DETAILED DESCRIPTION

In the detailed description that follows, reference is made to the appended drawings, which form part of this description and in which specific embodiments in which the disclosure may be executed are shown for purposes of illustration. In this respect, directional terminology, for instance “at the top”, “at the bottom”, “at the front”, “at the rear”, “front”, “rear”, etc. is used with reference to the orientation of the figure(s) described. Since components of embodiments may be positioned in a number of different orientations, the directional terminology serves for purposes of illustration and is in no way restrictive. It will be apparent that other embodiments may be used and structural or logical changes made without departing from the scope of protection of the present disclosure. It will be apparent that the features of the various embodiments described herein by way of example may be combined with one another, unless specifically stated otherwise. The detailed description that follows should therefore not be interpreted in a restrictive manner, and the scope of protection of the present disclosure is defined by the appended claims.

In the course of this description, the terms “connected” and “coupled” are used for describing both a direct connection and an indirect connection (for example ohmic and/or electrically conductive, e.g. an electrically conductive connection) and both a direct coupling and an indirect coupling. In the figures, identical or similar elements are provided with identical designations, wherever appropriate.

In various embodiments, the term “coupled” or “coupling” may be understood in the sense of a (for example mechanical, hydrostatic, thermal and/or electrical) connection and/or interaction, for example a direct or indirect connection and/or interaction. Multiple elements may be coupled to one another, for example, along a chain of interaction, along which the interaction (e.g. a signal) may be transmitted. For example, two mutually coupled elements may exchange an interaction with one another, for example a mechanical, hydrostatic, thermal and/or electrical interaction. In various embodiments, “coupled” may be understood in the sense of a mechanical (e.g. physical) coupling, for example by means of a direct physical contact. A coupling may be configured to transmit a mechanical interaction (e.g. force, torque, etc.).

An energy storage cell (also referred to as cell) may be understood to mean the smallest potential-generating unit in an energy storage, which has, for example, exactly one pair of cathode and anode. The energy storage cell provides the base potential of the energy storage, which, according to the interconnection, provides a voltage equal to the base potential or a voltage that may be a multiple of the base potential. The or each energy storage cell may have an active anode material (for example exactly one) (for example as a constituent of an active anode material layer) and an active cathode material (for example exactly one) (for example as a constituent of an active cathode material layer), which are connected to one another in a fluid-conducting and/or ion-conducting manner (for example by means of a cavity in which the electrolyte may have been or may be accommodated).

The electrochemical stability of a first material with respect to one or more than one second material (for example a mixture of two or more second materials) may depend on the nature of the respective material combination and may generally be based on exactly one material combination. The chemical stability of a first material with respect to a second material that may serve as reference material may be understood to mean the reciprocal of the reaction rate thereof with one another. The same applies in analogy when the first material is exposed to the mixture of two or more second materials.

The reaction rate indicates the amount of identical reactions in molar amount per unit time and volume (e.g. mol/(s·m³)) by means of the material combination (for example including the first material and the one or more than one second material). A high chemical stability results in high reaction inertness (meaning that the material combination barely interreacts, if at all). The chemical stability may depend, for example, on the pH of the material combination (for example of the reference material) or of the environment to which the first material is exposed. The pH range in which the first material is chemically stable may also be referred to as chemical stability window or pH stability window.

Within the pH stability window, the reaction rate may, for example, be less than 0.1% of the reaction rate outside the pH stability window. In other words, chemical stability is generally based on a material combination (e.g. aluminum/aluminum oxide and water), while the pH stability window is based more specifically on the chemical stability of this material combination between two pH values (that enclose a pH range).

The pH stability window of aluminum oxide is, for example, within a pH range from about 4.5 to about 8.5. Outside this range, there is corrosion of the native oxide layer of the aluminum, after which the metallic aluminum remains unprotected. The unprotected aluminum may then likewise corrode, i.e. chemically react, for example with water.

The reaction may proceed according to the following expressions:

Al₂O₃+2OH⁻+3H₂O->2 [Al (OH)₄]⁻

2Al+2OH⁻+6H₂O->2 [Al (OH)₄]⁻+3H₂

The [Al (OH)₄]⁻reaction product is soluble in water, meaning that the native oxide layer or the aluminum progressively reacts further with the water, and the reaction products formed dissolve therein, which is seen to drive corrosion further.

At high pH values (for example above 8.5), for example, various water-soluble aluminum compounds are formed, which may react with the constituents of the active cathode material layer and/or lead to agglomeration/sedimentation of these in the slip and/or on the current collector foil, may alter the rheological properties of the slip, and may impair the bond strength of the active cathode material layer on the current collector foil. These effects and the corroded aluminum itself may lower the current conductivity of the electrode, the lifetime thereof or the cycling stability thereof.

The pH of a material (for example of a liquid phase) may be regarded as the negative decadic logarithm of the hydrogen ion activity (e.g. oxonium activity) of the material. The activity of the hydrogen ion is the product of the molality of the hydrogen ion (m_{H+}in mol/kg) and the coefficient of activity of the hydrogen ion (γ_{H}) divided by the unit of molality (m⁰ in mol/kg). As a first approximation thereof, the oxonium activity for a dilute solution or suspension may be equated to the measure of the oxonium ion concentration (in mol/dm³ or mol/l).

In various embodiments, a foil (an aluminum foil or an aluminum-coated foil) may have a thickness (i.e. transverse to the lateral extent of the foil) of less than 40 μm, for example less than about 35 μm, for example less than about 30 μm, for example less than about 25 μm, for example less than about 20 μm, for example less than about 15 μm, for example less than about 10 μm, for example less than about 5 μm, for example within a range from about 3 μm to about 20 μm, for example about 5 μm or, for example, about 15 μm.

The foil may have, for example, a width, i.e. an extent in the direction of its lateral extent (for example at right angles to transport direction), within a range from about 0.01 m to about 7 m, for example within a range from about 0.1 m to about 5 m, for example within a range from about 1 m to about 4 m, and also a length, i.e. an extent in the direction of its lateral extent transverse to the width (for example parallel with respect to transport direction), of more than 0.01 m, for example more than 0.1 m, for example more than 1 m, for example more than 10 m (in that case the foil 302 may be transported, for example, from roll to roll), for example more than 50 m, for example more than 100 m, for example more than 500 m, for example more than 1000 m or several thousand meters.

In various embodiments, the foil may include a laminate composed of at least one plastic and aluminum. For example, the foil may include or have been formed from a polymer film coated (for example on one or two sides) with the aluminum. Alternatively, the foil may have been formed from the aluminum. For example, the foil may consist to an extent of more than 50 at % of the aluminum, for example to an extent of more than 70 at % of the aluminum, or, for example, to an extent of more than 90 at % of the aluminum.

In the context of this description, a metal (also referred to as metallic material) may more generally include (or have been formed from) at least one metallic element (i.e. one or more metallic elements), for example at least one element from the following group of elements: copper (Cu), iron (Fe), titanium (Ti), nickel (Ni), silver (Ag), chromium (Cr), platinum (Pt), gold (Au), magnesium (Mg), aluminum (Al), zirconium (Zr), tantalum (Ta), molybdenum (Mo), tungsten (W), vanadium (V), barium (Ba), indium (In), calcium (Ca), hafnium (Hf), samarium (Sm), or lithium (Li). In addition, a metal may include or have been formed from a metallic compound (e.g. an intermetallic compound or an alloy), for example a compound of at least two metallic elements (for example from the group of elements), for example bronze or brass, or, for example, a compound of at least one metallic element (for example from the group of elements) and at least one nonmetallic element, for example steel.

In general, solvents may be divided into protic and aprotic solvents. As soon as a molecule and/or a material made thereof has a functional group (e.g. an OH group) from which hydrogen atoms in the molecule may be detached as protons (dissociation), reference is made to a protic solvent. These contrast with the aprotic solvents. The protic solvent may include or have been formed from, for example, one or more than one of the following solvents: water, methanol, ethanol, an organic chemical compound of the alcohol type (also referred to as alcohol). The most important protic solvent is water which (in simplified form) dissociates into a proton and a hydroxide ion.

An electrolyte may be understood to mean a material or material mixture configured to conduct lithium ions, i.e. configured to be lithium ion-conductive. The electrolyte may include or have been formed from, for example, one of the following electrolyte types: a liquid and/or salt-based electrolyte (for example including or formed from a conductive salt, a solvent and optionally one or more than one additive), a polymer electrolyte, an electrolyte based on an ionic liquid, a solid-state electrolyte.

In various embodiments, an electrolyte may include at least one of the following: salt (such as LiPF₆ (lithium hexafluorophosphate), LiBF₄ (lithium tetrafluoroborate) or LiBOB (lithium bis(oxalato)borate)), anhydrous aprotic solvent (e.g. ethylene carbonate, diethyl carbonate, etc.), polyvinylidene fluoride (PVDF), polyvinylidene fluoride-hexafluoropropene (PVDF-HFP), Li₃PO₄N lithium phosphate nitride.

In various embodiments, a solid-state electrolyte may include at least one of the following: a superionic material from the group of the NASICONs (sodium-containing superionic conductors), a superionic material from the group of the LISICONs (lithium-containing superionic conductors), a sulfidic glass and/or LiPON (lithium phosphorus oxynitride).

In various embodiments, a foil processed by means of a method as described herein may be used in an energy storage, for example a battery, e.g. an accumulator, e.g. a lithium ion accumulator. In various embodiments, the foil may be used in one or every electrode (e.g. anode and/or cathode) of the energy storage.

An energy storage may include or have been formed from, for example, a specific lithium ion accumulator type, for example a lithium-sulfur accumulator, a lithium-nickel-manganese-cobalt oxide accumulator, a lithium-nickel-cobalt-aluminum oxide accumulator, a lithium-nickel-manganese oxide accumulator, a lithium-polymer accumulator, a lithium-cobalt dioxide accumulator (LiCoO₂), a lithium titanate accumulator, a lithium-air accumulator, a lithium-manganese dioxide accumulator, a lithium-manganese oxide accumulator, a lithium-iron phosphate accumulator (LiFePO₄), a lithium-manganese accumulator, and/or a lithium-iron phosphate accumulator. The first part of this notation may correspond to the main reactive material (e.g. lithium) and the second part of the notation may correspond to the active cathode material. More generally speaking, the energy storage may include or have been formed from an Li ion accumulator, for example an Li-LFP accumulator, Li-NMC accumulator, Li-S accumulator, Li-O accumulator, or the like.

In various embodiments, the protective layer may have a thickness (layer thickness, i.e. transverse to the lateral extent of the foil) within a range from about 5 nm (nanometers) to about 1 μm (micrometer), for example within a range from about 10 nm to about 200 nm or within a range from about 5 nm to about 500 nm, for example within a range from about 100 nm to about 200 nm. Alternatively or additionally, the protective layer may include or have been formed from a second metal different than the first metal. For example, the protective layer may consist to an extent of more than 50 at % of the second metal, for example to an extent of more than 70 at % of the second metal, or, for example, to an extent of more than 90 at % of the second metal.

An active material may, in various embodiments, have been provided or be provided as part of an active material layer. In general, the active material may also have been provided or be provided in some other way and may therefore be referred to more generally hereinafter as active material. What has been described in respect of the active material may also be analogously applicable to an active material layer.

An active material (for example the active anode material and/or the active cathode material), for example an active material layer, may generally have a high specific surface area, for example greater than that of the foil and/or the protective layer. For this purpose, the active material, e.g. the active material layer, may be porous, for example, i.e. have pores or other voids, for example a network of mutually connected pores and/or passages. For example, the active material may have a porosity within a range from about 10% to about 80% (for example within a range from about 20% to about 40% or to about 80%). Alternatively, the active anode material may have a compact lithium layer (e.g. a lithium metal anode). For example, it is possible to use a pore-free lithium metal layer as active anode material.

In various embodiments, an active material layer or an active material may have a thickness (layer thickness, i.e. transverse to the lateral extent of the foil) within a range from about 5 μm to about 500 μm, for example within a range from about 5 μm to about 100 μm.

For example, the active material may have been provided or be provided as part of a mixture (for example as part of an active material layer, such as active anode material layer and/or active cathode material layer), where the mixture may include or have been formed from: the active material, one or more than one conductive additive (for example conductive black, carbon nanotubes and/or carbon fibers), and/or one or more than one binder material (e.g. polytetrafluoroethylene, polyethylene oxide, styrene-butadiene rubber, carboxymethyl celluloses, polyvinylidene fluoride, etc.). The binder material may include or have been formed from a polymer for example. The active material may be the active anode material or the active cathode material.

In the context of this description, the active anode material may include or have been formed from, for example, one or more than one of the following materials: carbon (for example graphite, hard carbon, carbon black), silicon, silicides, lithium, lithium titanate (Li₄Ti₅O₁₂), tin, zinc, aluminum, germanium, magnesium, lead, antimony or transition metal oxides, sulfides, nitrides, phosphides, fluorides (AₓB_{y} with A=Fe, Co, Cu, Mn, Ni, Ti, V, Cr, Mo, W, Ru and B=O, S, P, N, F; for example Cr₂O₃). More generally speaking, the active anode material may be a material that lithiates, i.e. reacts electrochemically with lithium (for example a lithium compound), and/or intercalates lithium.

In the context of this description, the active cathode material may include or have been formed from, for example, one of the following materials: lithium-iron phosphate (LFP), lithium-nickel-manganese-cobalt oxide (NMC), lithium-manganese oxide (LMO), lithium-nickel-cobalt-aluminum oxides (NCA), lithium-nickel-manganese oxide (LNMO), lithium-cobalt oxides (LCO), lithium-vanadium oxide (LVO), lithium-manganese phosphate (LMP), lithium-nickel phosphate (LNP), lithium-cobalt phosphate (LCP), lithium-vanadium phosphate (LVP), lithium sulfide or lithium oxide.

If a carbon layer is deposited on a current collector from the liquid phase (for example from a suspension or dispersion), a thickness of 5 μm or more may be required, illustratively, in order to achieve a good electrochemical performance of the electrode (similarly to the electrode produced with NMP slips); and/or in order to prevent corrosion of the aluminum foil in an aqueous slurry and the associated adverse effects on the processibility and/or the electrochemical properties of the electrode. However, this liquid-deposited carbon layer is difficult to convert to mass production. Firstly, the liquid-deposited carbon layer, owing to its layer thickness, has a tendency to leafing, thus making it difficult to roll up the current collector if the intention is to avoid leaks in the carbon layer.

Illustratively, leakage in the carbon layer may lead to corrosion at this site, which gradually covers noticeable areas of the current collector. If, however, the current collector is not to be processed from the roll, large costs arise owing to the complex process regime. The carbon layer may alternatively be an inactive component in the later energy storage cell that reduces the specific energy and/or energy density of the energy storage cell according to its proportion by weight. In addition, a thick carbon layer may lead to an elevated internal resistance of the energy storage cell. For example, a low thickness of a carbon layer is associated with a low loss of functionality of the energy storage cell.

The low apparent density of a granular liquid-deposited carbon layer may be a parameter that may be compensated for only with difficulty. With decreasing thickness of the carbon layer, the current collector may be increasingly unprotected or inadequately protected. Any convex curvature in the rolling-up of the current collector (for example in the case of a round cell) may lead to a decrease in the apparent density of the carbon layer, which further increases the required thickness of the carbon layer.

On the other hand, a thinner liquid-deposited carbon layer has a tendency to have a residual porosity, such that, particularly in the case of larger areas, there is an increasing risk of leaks in the carbon layer.

However, alternative conventional approaches for the use of water may not achieve the performance of NMP. For example, in a conventional manner, by means of a corona treatment, the wetting of the slip based on water as solvent on straight aluminum foil is improved. However, this approach does not inhibit either the corrosion of the aluminum foil or the leaching-out of the active material. Alternatively, an acid is added to the slip for neutralization thereof. It is thus possible to inhibit the corrosion of the aluminum foil, but the active material leached out may not achieve its full performance. The addition of acid to the slip may likewise lead to reactions with and hence worsening of the active material. It may likewise be necessary also to monitor the pH of the slurry during the drying.

Alternatively, in a conventional manner, the active material is coated with an organic material (for example with a fluorine-containing polymer) or inorganic material (for example with Al₂O₃ or ZrO₂). This does inhibit the leaching-out of the active material, but does not reliably inhibit the corrosion of the aluminum foil and the agglomeration and is costly.

If NMP is used as solvent, the processing has to be effected in dry rooms at great cost and inconvenience, so that it does not absorb any water. The energy storage/method provided in various embodiments make it possible for the NMP to absorb water and put the liquid phase to be alkaline as a result without corrosion of the current collector foil used during the electrode production.

In various embodiments, an energy storage and a method are provided, which enable simplification of the production of an electrode, specifically of the cathode, from slips based on water as solvent (ideally even completely without other solvents). In various embodiments, what is enabled by the energy storage provided and the method provided is that this electrode has lower losses in its electrochemical performance (for example with regard to its capacity, cycling stability, rate capacity, etc.) than conventional approaches for electrode production based on water as solvent.

Illustratively, for example, one of the following may have been provided or be provided:
a coating of the active material for protection from leaching-out and/or for inhibition of agglomeration;
a coating of the metallic current collector substrate (especially of aluminum) for protection from corrosion and for homogeneous wetting of the slip on the current collector substrate.

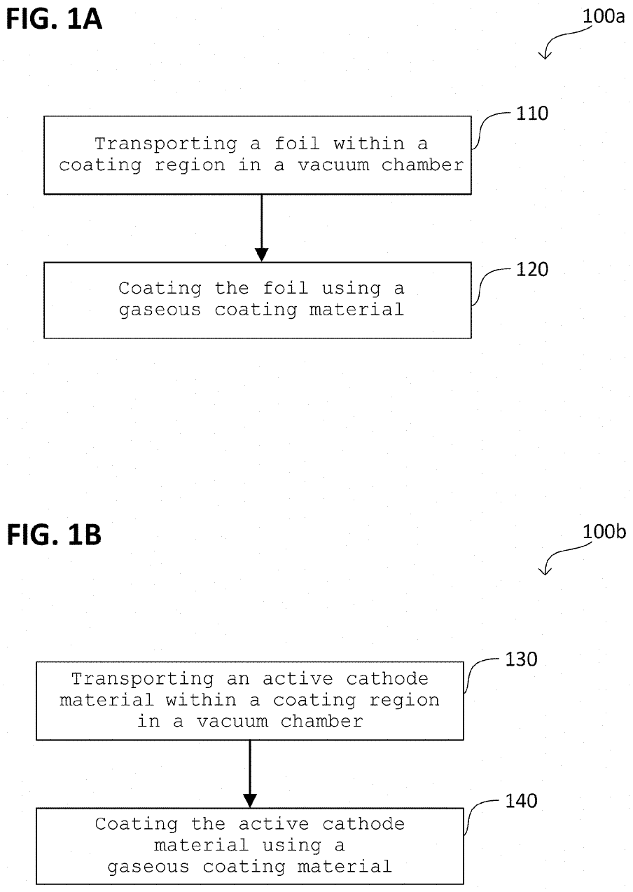

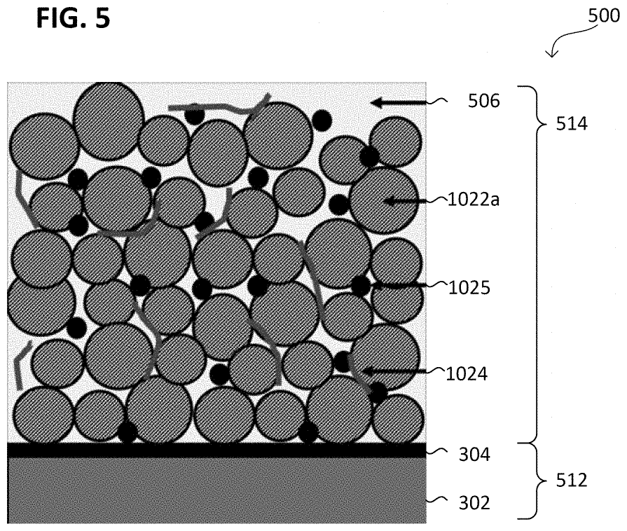

FIG. 1A illustrates a method 100a in various embodiments in a schematic flow diagram that provides, for example, a coated foil 512 (cf. FIG. 5).

The method 100a may include, in 110: transporting a foil within a coating region disposed, for example, in a vacuum chamber and/or having a vacuum, wherein the foil includes or has been formed from aluminum. For example, the foil may be transported within a coating region of a vacuum chamber, where the foil has a metallic surface composed of aluminum or a native oxide layer on the surface of the aluminum.

The method 100a may include, in 120: coating of the foil with a protective layer 304 using a gaseous coating material. The coating may include: producing material vapor (also referred to as gaseous coating material) in the coating region or the vacuum. The coating may also include: forming an electrically conductive protective layer (also referred to as contact layer) on the metallic or native oxide surface of the foil, wherein the electrically conductive protective layer is formed from at least the material vapor.

In various embodiments, the coating of the foil with a protective layer may be effected by means of a physical gas phase deposition (PVD), for example by evaporating the protective material. Alternatively, the coating of the foil with the protective layer may be effected by means of a chemical gas phase deposition (CVD), for example by means of atomic layer deposition (ALD). Illustratively, such a vacuum-based coating or coating from the gas phase may enable a very thin protective layer that may be fluid-tight and/or ion-tight.

In various embodiments, a vacuum-based method for (for example optionally single-sided or double-sided) deposition of the protective layer is provided. This method may be applied, for example, to thin aluminum foils (Al foils) or other foils having an aluminum surface, for example to an aluminum-finished polymer foil. In various embodiments, by means of the method, one or more than one electrically conductive current collector having low surface contact resistance which is chemically resistant to an alkali (i.e. an alkaline slurry or solution) is provided.

For this purpose, the method, in various embodiments, may also include: optionally removing a surface layer (for example at least the native passivation layer) of the foil (for example prior to the coating) for at least partial exposure of the metallic aluminum in the foil, so as to form a (for example exposed) aluminum surface. The surface layer may be removed using a plasma, i.e. by means of what is called plasma etching.

In various embodiments, the gaseous coating material (also referred to as material vapor) may include or have been formed from a metal (e.g. Ni, Ti or Cu). For example, the gaseous coating material may include or have been formed from titanium. Using the gaseous coating material including or formed from at least titanium, a titanium layer, for example, may have been formed or be formed as protective layer.

In various embodiments, the protective layer may have a geometric space filling, i.e. the ratio of apparent density to true density, of more than about 80%, for example more than about 90%, for example about 100%. In other words, the microstructure of the protective layer may have a proportion of pores or voids in the total volume (for example of a coating) of less than about 20%, for example less than about 10%, for example less than about 5%, for example less than about 1%. Illustratively, the protective layer is then essentially free of pores or voids.

The protective layer may increase the chemical stability of the foil to an alkaline environment (for example of the alkali), for example for use in manufacture of an electrode for an energy storage cell, for example a lithium ion battery.

More generally speaking, rather than the foil, another substrate may also have been coated or be coated, for example a two-dimensional substrate and/or one in ribbon form. In this way, a passivated substrate 512 (cf. FIG. 5) is provided, on which the active material layer (for example including the active cathode material) may be applied homogeneously from a slurry based on a protic solvent, e.g. water, with good wetting and without corrosion of the substrate.

For example, a protective layer on a metallic current collector substrate is provided. It is possible in this way to enable fulfillment by the coated current collector substrate of the demands (for example on corrosion resistance and/or homogeneous wetting) on electrode production with slips based on water as solvent. This current collector substrate may have been coated or be coated, for example, by means of the protective layer, for example a barrier layer, and/or with a hydrophilic protective layer, such that it meets the demands. Rather than the current collector, it is also possible for another substrate including aluminum to have been coated or be coated, for example a two-dimensional substrate.

The protective layer may, for example, (e.g. irrespective of the substrate type or substrate material chosen), include or have been formed from a carbon layer (also referred to as C layer). The carbon layer may have been formed or be formed by means of PVD for example. The carbon layer may have, for example, a thickness within a range from about 2 nm (nanometers) to about 2 μm (micrometers), e.g. 2 μm or less, for example within a range from about 10 nm to about 1 μm, for example within a range from about 10 nm to about 200 nm.

The carbon layer may include or have been formed from carbon (C) for example. For example, the carbon layer may consist to an extent of more than 50 at % of the carbon, for example to an extent of more than 70 at % of the carbon, or, for example, to an extent of more than 90 at % of the carbon. The carbon may be present in a carbon configuration, for example amorphous carbon (for example from the group of the diamond-like carbons—DLC), graphite, nanocrystalline graphite, tetrahedral carbon and/or tetrahedral-amorphous carbon (ta-C).

The protective layer (for example the carbon layer) may optionally have been configured to be or become hydrophilic.

“Hydrophilic” may be understood to mean that the surface has a contact angle with respect to water close to 0°, for example less than 10°. The greater the degree of hydrophilicity, the smaller the contact angle may be.

The hydrophilicity (that defines the contact angle of a water droplet) of the protective layer, for example of the carbon layer, may be formed and/or improved, for example, by means of an aftertreatment of the protective layer. The aftertreatment may include, for example, irradiating the protective layer (for example carbon layer), for example by means of light, for example by means of pulsed light, for example by means of flashlamps (also referred to as flashlamp annealing).

In an analogous manner, it is also possible for another protective layer 304 (for example of another material) to have been configured to be or become hydrophilic. If the protective layer may be configured to be hydrophilic only with difficulty or is hydrophobic, for example when this material has a metal surface, it may alternatively have been coated or be coated with a hydrophilic carbon layer (also referred to as increasing the degree of hydrophilicity). For example, a graphene layer may be hydrophilic and form the uppermost layer of the protective layer. Alternatively, to increase the degree of hydrophilicity, a different surface treatment and/or coating operation may be effected. The degree of hydrophilicity may be increased, for example, by means of a corona treatment. The increase in the degree of hydrophilicity may permit improved wetting, i.e. an improved electrode synthesis.

Optionally, an interlayer (also referred to as buffer layer) may have been disposed or be disposed between the substrate and the carbon layer. The interlayer may be part of the protective layer and may have been configured to relieve the intrinsic lateral tension of the (for example amorphous) carbon layer with respect to the substrate. The interlayer may include or have been formed from, for example, a material having carbon affinity, for example a metal, e.g. Cu, Ti, Ni, Al, TiN, or the like. The metal in the interlayer may have an electrical conductivity greater than 10⁴ S/m, for example greater than 10⁵ S/m.

Illustratively, the interlayer may be configured preferably with high electrical conductivity to inhibit interactions between the substrate 302 and the carbon layer 304, especially interdiffusion and/or the formation of metal carbides.

By comparison with solvent-based processes, a protective layer produced by means of PVD (e.g. carbon layer) may be significantly thinner, such that, firstly, the increase in weight of the current collector may be reduced and/or else the contact resistance may be lower. A solvent-based protective layer is produced by deposition from a dispersion, which does not give a compact, impervious layer (especially at low thicknesses). A solvent is also required, which may be toxic and/or costly.

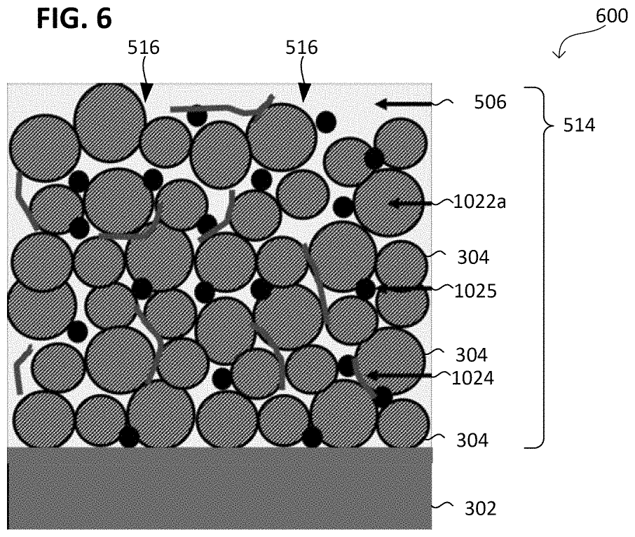

FIG. 1B illustrates a method 100b in various embodiments in a schematic flow diagram that provides, for example, coated solid particles 516 (cf. FIG. 6).

The method may be configured in the same way as the method 100a, except that, alternatively or additionally to the foil, the active cathode material is coated.

The active cathode material may be in granular form (i.e. as granules). In other words, the active cathode material may include a multitude of solid particles (the granules) that are coated.

The coating of the solid particles may include emitting the solid particles into a vacuum and providing gaseous coating material in the vacuum, from which the protective layer on the solid particles is formed.

This vacuum-based coating or coating of the active cathode material (for example of the solid particles) from the gas phase may enable a very thin protective layer that may be fluid-tight and/or ion-tight. By comparison with other coating types, this may thus assume a lower proportion by weight in the cathode, provide a higher current conductivity and/or be producible at lower cost, which thus makes the cathode more economically viable.

The protective layer may include or have been formed from a protective material for example. The protective material may include or have been formed from carbon for example, for example in a carbon modification.

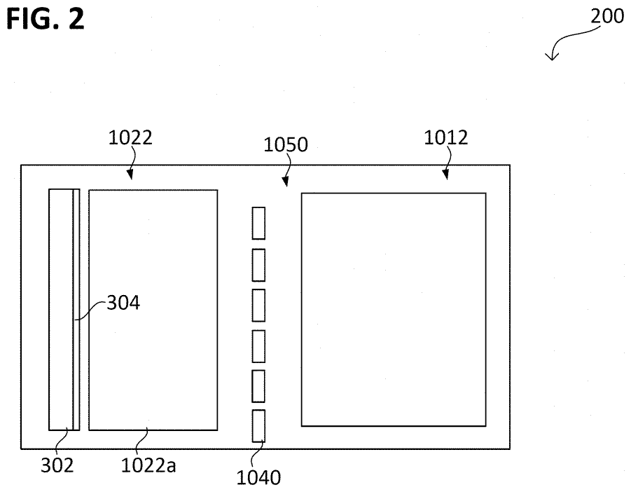

FIG. 2 illustrates an energy storage having one or more than one energy storage cell 200 (also referred to as element of the energy storage cell), in various embodiments in a schematic side view or a schematic cross-sectional view.

The energy storage may include one or more than one energy storage cell 200, where the or each energy storage cell 200 may have been or may be arranged periodically for example (for example in stacked form or in coiled form) in the energy storage. For example, the energy storage may be a round energy storage, a pouch energy storage, or a prismatic energy storage.

Optionally, the or each energy storage cell 200 may include a separator 1040 as described in more detail hereinafter. For example, the or each energy storage cell 200 may include a liquid electrolyte 1050 and the separator for electrical separation of the electrodes. Alternatively, the or each energy storage cell 200 may include a solid electrolyte 1050 configured for electrical separation of the electrodes, in which case the separator may be omitted, or may be necessary in the case of some types of solid electrolyte 1050.

The energy storage, for example the or each energy storage cell 200, may, in various embodiments, have an anode 1012 that has a first chemical potential (also referred to as anode potential) (for example first electrochemical potential).

The energy storage, for example the or each energy storage cell 200, may also have a anode 1022 that has a second chemical potential (also referred to as cathode potential) (for example second electrochemical potential). The cathode 1022 may include a foil 302 (for example an electrically conductive foil 302) that includes or consists of the aluminum.

The chemical potential described herein may be an electrochemical potential.

In addition, the cathode 1022 may include a protective material 304 with which the foil 302 has been coated (also referred to as protective layer 304), where the protective material includes a metal other than aluminum and/or carbon. The protective layer 304 may be in physical contact, for example, with the aluminum in the foil 302.

The coating 304 of the protective material 304 (i.e. the protective layer 304) may have been configured to be fluid-tight for example. The coating 304 of the protective material 304 (i.e. the protective layer 304) may have been configured, for example, to be inert to an alkaline environment having, for example, a pH of about 8.5 or more, for example about 9 or more, for example about 9.5 or more, for example about 10 or more. “Inert” may be understood to mean that the protective material 304 is chemically stable to the alkaline environment.

In addition, the cathode 1022 may have an active cathode material layer arranged alongside (for example atop) the protective layer 304, for example in physical contact therewith. The active anode material layer may include the active cathode material 1022a.

The protective layer 304 may be an electrically conductive layer, for example in the form of an electrical contact layer disposed between the foil 302 and the active cathode material layer 1022a.

An electrical potential may develop between the anode 1012 and the cathode 1022, for example when the energy storage, for example the or each energy storage cell 200, has been or is charged, which corresponds roughly to the differential between the first chemical potential and the second chemical potential. Such an energy storage may have one or more than one such energy storage cell 200 (for example connected in parallel to one another or in series with one another).

An electrical potential may develop between anode and cathode (both in the charging and discharging operation, and also in the power-off state) when the electrodes are connected via an ion-conducting medium 1040 (e.g. electrolyte 1050, in solid or liquid form).

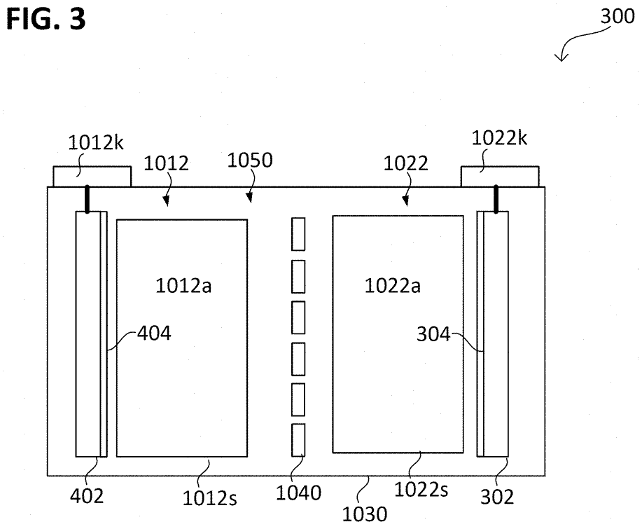

Illustratively, the foil 302 may function as current collector or current conductor for provision or tapping of the electrical charges that are stored or released at the anode 1012 or the cathode 1022 in the electrochemical reduction or oxidation reactions, for example when the energy storage, for example the or each energy storage cell 200, is being charged or discharged. The lithium ions that move between the anode 1012 and the cathode 1022 in the (liquid or solid) electrolyte 1050 (ion exchange) may bring about a conversion of stored chemical energy (for example when the energy storage, for example the or each energy storage cell 200, has been charged) to electrical energy, where the electrical energy provides an electrical potential between the electrodes 1012, 1022 and/or between the contact connections 1012k, 1022k coupled thereto (cf. FIG. 3).

The electrical energy may be the product of current, potential and time (i.e. E=U*I*t). The potential U is found from the electrochemical potentials of anode/cathode and is variable with the charge state of the cell. The current I may be provided (discharging) or consumed (charging), and is coupled to the spatial flow of lithium ions (Li⁺+e⁻←→ Li). The time t corresponds to the duration with which current is being provided or consumed, i.e. for how long discharging or charging is being effected, for example a current-consuming load is attached.

In various embodiments, the energy storage, for example the or each energy storage cell 200, may provide an average electrical voltage of more than about 3.5 volts (V), for example of more than about 3.7 V, for example of more than about 4 V. The average electrical voltage may correspond to the average value between the potential in the discharged state and the potential in the charged state of the energy storage cell 200, i.e. be a charge cycle-averaged potential.

The potential of the or each energy storage cell 200 may vary depending on the charge state. If the energy storage cell 200 has been discharged, the potential may be low, for example about 3.0 V in the case of an LIB energy storage cell 200 or within a range from about 2.5 V to about 3.5 V. If the cell has been charged, the potential may, illustratively, be high, for example about 4.3 V in the case of an LIB energy storage cell 200, for example within a range from about 3.7 V to about 5.0 V.

In general, the or each energy storage cell 200 (for example an Li/S energy storage cell 200) may provide a cell potential of about 1.8 V or more in the discharged state and of about 2.6 V in the charged state. A lithium-air energy storage cell 200 may provide a potential of about 2.0 V in the discharged state and up to about 4.8 V in the charged state.

Optionally, the foil 302 may have been coated or be coated with the protective layer 304 on either side.

The active cathode material 1022a may include or have been formed from lithium iron phosphate (LFPO) for example (for example in a lithium iron phosphate energy storage), may include or have been formed from lithium manganese oxide (LMO) (for example in a lithium manganese oxide energy storage) or include or have been formed from lithium-nickel-cobalt-aluminum oxides (NCA), lithium-nickel-manganese oxide (LNMO), lithium-cobalt oxides (LCO), lithium-vanadium oxide (LVO), lithium-manganese phosphate (LMP), lithium-nickel phosphate (LNP), lithium-cobalt phosphate (LCP), lithium-vanadium phosphate (LVP), lithium sulfide or lithium oxide.

In various embodiments, the active cathode material 1022a may have been applied or may be applied to the foil 302 having a protective layer 304 together with optional further constituents of the active cathode material layer (for example binder, and/or conductivity additive) (for example by means of a liquid phase, i.e. disposed in a solvent) by means of a ribbon coating system, for example by means of liquid phase deposition, for example by means of a spray coating operation, a curtain coating operation, a comma-bar coating operation and/or a slot-die coating operation.

Optionally, in a subsequent drying process (in which the foil 302 having the protective layer 304 is heated for example), remaining solvent may be extracted from the active cathode material layer. This may result in solidification of the liquid phase, for example of the active cathode material layer 1022a.

The forming of the energy storage, for example of the or each energy storage cell 200, may include: applying the active cathode material 1022a (for example by means of the active cathode material layer) to the foil 302 coated with the protective layer 304, to form a cathode 1022 having the cathode potential; joining the anode 1012 to the cathode 1022 (optionally separately by a solid electrolyte 1050 and/or a separator 1040), where the anode 1022 has the anode potential; and encapsulating 1030 the anode 1012 and the cathode 1022. In other words, the energy storage, for example its or each energy storage cell 200, may have an encapsulation 1030 that surrounds the anode 1012 and the cathode 1022. Optionally, a liquid electrolyte 1050 may be introduced into the energy storage cell prior to encapsulation thereof.

Optionally, the forming of the energy storage, for example of the or each energy storage cell 200, may also include: forming a contact connection for contacting of the foil 302 of the cathode 1022. For example, the forming of the energy storage, for example of the or each energy storage cell 200, may also include: forming an additional contact connection for contacting of the anode 1012.

The energy storage, for example the or each energy storage cell 200 of the energy storage, may, for example, be a high-energy storage. The high-energy storage may provide an electrical voltage of more than 4 volts per cell. The cell voltage may be variable and depend on the cell system. For example, an Li/S energy storage cell 200 may provide a high specific energy coupled with a low average cell potential. The active material absorbs more lithium, which leads to a higher capacity. The energy may correspond to the product of potential and capacity.

Illustratively, a high-energy cell may provide a high specific energy, for example about 100 Wh/kg or more, e.g. 150 Wh/kg or more, e.g. 200 Wh/kg. Alternatively or additionally, a high-energy cell may provide a high energy density, e.g. 300 Wh/l or more, e.g. 400 Wh/l or more, e.g. 500 Wh/l or more.

For example, the foil 302 may be an aluminum foil having a thickness within a range from about 9 micrometers (μm) to about 20 μm.

FIG. 3 illustrates an energy storage having, for example, one or more than one energy storage cell 300, in various embodiments in a schematic side view or a schematic cross-sectional view.

In various embodiments, the anode 1012 may have a first foil 402 (also referred to as anode foil 402) and the cathode 1022 may have a second foil 302 (also referred to as cathode foil 302).

In addition, the anode 1012 may have an active anode material layer 1012s which is or has been disposed atop the anode foil 402. The active anode material layer 1012s may provide the first chemical potential.

The active anode material layer 1012s may differ from the active cathode material layer 1022s, for example in terms of electrochemical potential or chemical composition.

The active anode material layer 1012s, for example the active anode material thereof 1012a, may include or have been formed for example from graphite (or carbon in another carbon configuration), include or have been formed from nanocrystalline and/or amorphous silicon, or include or have been formed from lithium metal.

Optionally, the anode foil 402 may include or have been formed from aluminum or copper.

Optionally, the anode foil 402 may have a coating 404 (also referred to as anode foil coating), for example of the same material as the protective material 304 of the cathode foil 302.

In addition, the energy storage, for example the or each energy storage cell 300, may have a first contact connection 1012k which is in electrical and/or physical contact with and/or coupled to the anode 1012, and is connected in an electrically conductive manner to the anode foil 402 for example. The first contact connection 1012k may have an exposed surface.

In addition, the energy storage, for example the or each energy storage cell 300, may have a second contact connection 1022k which is in electrical and/or physical contact with and/or coupled to the cathode 1022, and is connected in an electrically conductive manner to the cathode foil 302 for example. The second contact connection 1022k may have an exposed surface.

The electrical potential (also referred to as cell potential) may develop between the first contact connection 1012k and the second contact connection 1022k, for example when the energy storage, for example the or each energy storage cell 300, has been charged, which corresponds roughly to the differential between the first chemical potential and the second chemical potential. The cell potential may develop after the introduction of the electrolyte into the energy storage, for example the or each energy storage cell 300.

Optionally, the energy storage, for example the or each energy storage cell 300, may have a separator 1040. The separator 1040 may separate the anode 1012 and the cathode 1022, in other words the negative and positive electrode, spatially and electrically from one another. However, the separator 1040 may be permeable to lithium ions that move between the anode 1012 and the cathode 1022 through the solid or liquid electrolyte 1050. The lithium ions that move between the anode 1012 and the cathode 1022 may bring about a conversion of stored chemical energy (for example when the energy storage, for example the or each energy storage cell 300, has been charged) to electrical energy, where the electrical energy may be the product of electrical current, electrical potential and time (i.e. E=U*I*t), as described above. The electrical potential may have been provided or may be provided at the contact connections 1012k, 1022k. The separator 1040 may include or have been formed from a microporous plastic (for example polypropylene or polyethylene, or combinations thereof), and/or the separator may include or have been formed from a nonwoven, for example glass fibers. Optionally, the separator may include embedded ceramic particles or a ceramic coating. Optionally, the separator 1040 may include multiple layers of different chemical composition, for example three layers (also referred to as a trilayer separator), for example the following sequence: polypropylene/polyethylene/polypropylene.

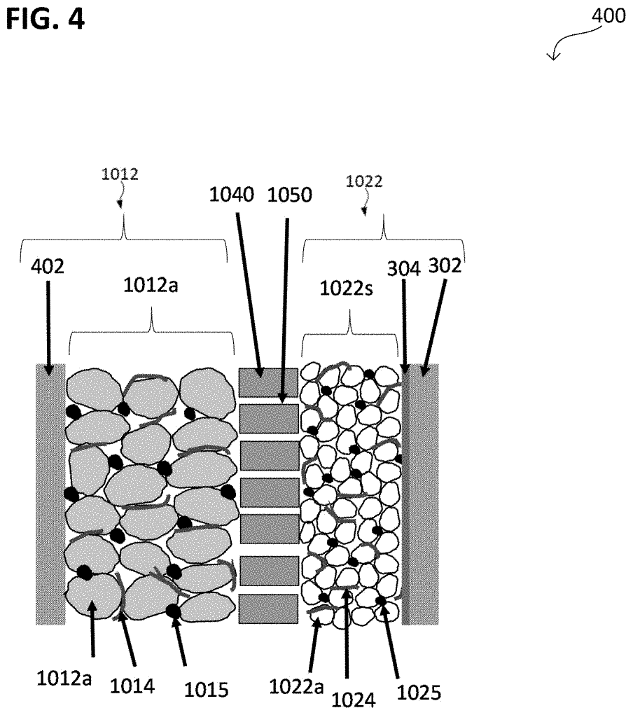

FIG. 4 illustrates an energy storage having, for example, one or more than one energy storage cell 400, in various embodiments in a schematic side view or a schematic cross-sectional view.

The energy storage, for example the or each energy storage cell 400, may have: an aluminum-containing cathode foil 302 (e.g. aluminum foil 302), a (for example fluid-tight and/or ion-tight) protective layer 304, for example in physical contact with the cathode foil 302, a porous active cathode material layer 1022s, for example in physical contact with the protective layer 304.

The energy storage, for example the or each energy storage cell 400, may include: an ion-conductive separator 1040, an optional (for example liquid or solid) electrolyte 1050, a porous active anode material layer 1012a, and an anode foil 402.

The active cathode material layer 1022 may include or have been formed from: a granular active cathode material 1012a, optionally one or more than one binder material 1024, and/or optionally one or more than one conductive additive material 1025. The active anode material layer 1012s may include or have been formed from: a granular active anode material 1013, optionally one or more than one binder material 1014, and/or optionally one or more than one conductive additive material 1015.

Illustratively, a material which has high electrical conductivity and is chemically unstable to an alkaline environment (e.g. aluminum) may be used as cathode current collector and this may have been protected or may be protected by a protective layer (for example of Cu, Ti, Ni, TiN, C or the like). The material of the protective layer (also referred to as protective material) may be chemically stable to the alkaline environment, for example the liquid phase from which the active cathode material layer 1022s is formed. The protective layer 304 may be an impervious, compact layer, optionally having high electrical conductivity.

FIG. 5 illustrates an energy storage having, for example, one or more than one energy storage cell 500, in various embodiments in a detailed schematic side view or a schematic cross-sectional view, for example in a method according to various embodiments. The illustrated configuration may show, for example, the cathode in detail, for example in a state of the cathode directly after application of the slurry 514 to the current collector 302 (for example the cathode foil).

By means of the method, it is possible to simplify the production of an LIB electrode, for example an LIB cathode 1022, from a slurry 514 based on water as solvent.

The forming of a cathode 1022 may, in various embodiments, include: providing a foil 302 coated with a protective material 304 formed from the gas phase (also referred to as coated foil 512 or passivated foil 512); coating the foil 512 coated with the protective material with an alkaline slurry 514 including a solvent 506 and a useful layer material 1022a, 1024, 1025 (also referred as to usage-layer material).

The passivated foil 512 may be provided, for example, by the method 100a. Reference is made hereinafter for simpler understanding to the passivated foil 512, which, however, may also be another passivated substrate 512, for example a two-dimensional substrate or one in ribbon form and/or sheet form. The protective material 304 formed from the gas phase is, for example, more impervious and more compact and forms a thinner protective layer 304 than protective material 304 deposited from the liquid phase.

More generally speaking, the coating may be effected in an alkaline environment, for example by means of an alkaline mixture, for example an alkaline liquid/solid particle mixture (for example a slurry, a suspension or a colloid). Reference is made hereinafter, for simpler understanding, to the slurry, which, however, may also be a different, for example finer or coarser, viscous mixture 514 (also referred to as liquid phase 514).

The slurry 514 may include or have been formed from, for example, a dispersion (for example suspension), i.e. a fine distribution of the useful layer material 1022a, 1024, 1025 in solid form (also referred to as solid particles) that float in the solvent 506. The slurry may be regarded as a viscous fluid mixture consisting at least of a pulverized solid (also referred to as solid particles) and a liquid (the solvent). The slurry may be free-flowing, for example under gravity.

The useful layer material 1022a, 1024, 1025 may generally include or have been formed from a lithium-containing material that is to be applied from the slurry 514 to the passivated foil 512. The useful layer material 1022a, 1024, 1025 may in other words include lithium, for example a lithium compound. The useful layer material 1022a, 1024, 1025 may, for example, include one or more than one electrode constituent, for example a binder 1024 (e.g. an organic binder), a conductivity additive 1025 (e.g. metal particles), and/or the active cathode material 1022a. More generally speaking, the slurry 514 may include one or more than one electrode constituent that may include lithium.

The starting point for formation of the slurry 514 may be (for example specifically) the solvent 506, for example water or another polar and/or protic solvent. In other words, the solvent 506 may be polar and/or protic. For example, the slurry 514 may include solely water as solvent 506. Alternatively or additionally, the solvent 506 may include or have been formed from an alcohol, e.g. ethanol and/or isopropanol.

By means of various mixing processes, the one or more than one electrode constituent (for example the active material, the binder and/or one or more than one conductivity additive, etc.) or another useful layer material may have been dispersed or may be dispersed into the solvent (also referred to as slurrying).

Optionally, one or more than one constituent of the useful layer material 1022a, 1024, 1025 (e.g. lithium from the active cathode material) may have been transferred to the solvent 506. Accordingly, the slurry 514 may include a solvent in which lithium for example is present. As soon as lithium is extracted from the active cathode material, it may react, for example, with water and form OH—and H₂, for example according to the following expression:

2Li+2H₂O→2Li⁺+2OH⁻+H₂.

As a result, the slurry 514 may be alkaline, for example with a pH of more than 8.5 (or 9). This process may be time-dependent and lead to a higher pH the longer the useful layer material 1022a, 1024, 1025 is in the solvent 506.

The slurry 514 may have been applied or may be applied to the passivated foil 512 (for example the passivated current collector 512), for example by means of a slot die, by means of a comma bar or by means of a patterned roller, such that a slurry layer 514 is formed on the passivated foil 512. Subsequently, the solvent may be discharged by means of a drying process (for example by means of a drying process that includes, for example, one or more than one drying zone) (also referred to as solidifying).

The coating may include, for example, bringing the alkaline slurry 514 into physical contact with the protective material 304, for example wetting it with the slurry 514, for example covering it to an extent of more than 80%. By means of the coating, it is possible to form a viscous layer 514 that includes or has been formed from the alkaline slurry 514 on the foil 302. The viscous layer 514 may thus have been brought into or be brought into physical contact with the protective material 304.

The coating of the passivated foil 512 may be followed by solidification of the viscous layer 514 (for example of the alkaline slurry 514). The solidification may include extracting the solvent 506 from the viscous layer 514. The extracting may include reducing a concentration of the solvent 506 in the viscous layer 514. As a result, it is possible for a strength (for example a mechanical hardness) and/or a viscosity of the viscous layer 514 to increase, and, for example, a solid layer 514 to be formed.

The extracting of the solvent 506 may have the result, for example, that the solvent 506 between the solid particles is extracted, leaving voids (also referred to as pores). In other words, the solidifying of the layer 514 may include increasing a porosity of the layer 514. Thus, by means of the solidification of the layer 514, a porous layer 514 (also referred to as active material layer) may have been formed or may be formed.

By means of the optional binder 1024, it is possible here to bond the solid particles (for example of the active cathode material 1022a). The optional conductive additive 1025 may accumulate between the solid particles, for example in the pores formed.

The drying process may be effected, for example, in dry air and/or with the supply of thermal energy (for example via thermal radiation).

The foil 302 (for example the substrate 302) may include or have been formed from a metallic foil, for example including or formed from aluminum. The foil 302 may be used, for example, as current collector of the cathode, or else alternatively as current collector of the anode. The current collector of the anode may include or have been formed from copper for example. As an alternative to the metallic foil, the foil may include a carrier in ribbon form which may have been or may be aluminum-coated. For example, the foil 302 may have an aluminum coating on a non-metallic ribbon, for example an aluminum-coated polymer film and/or carbon film.

Optionally, the solidification of the layer 514 (for example the driving-out of water) may include monitoring the pH of the layer 514.

The slurry 514 may optionally include N-methyl-2-pyrrolidone and water. This makes it possible, in the case of conventional manufacture based on N-methyl-2-pyrrolidone, to dispense with at least the high cost and inconvenience involved in a low-water manufacturing environment. Illustratively, it may be accepted that the slurry 514 provided on the basis of N-methyl-2-pyrrolidone will absorb water since this remains harmless owing to the protective material. Alternatively, the slurry 514 may be free of N-methyl-2-pyrrolidone. This also enables provision of a manufacturing environment that has less than the toxicity and/or reproductive toxicity emanating from the slurry 514.

FIG. 6 illustrates an energy storage (for example similar to FIG. 5) having, for example, one or more than one energy storage cell 600, in various embodiments in a schematic side view or a schematic cross-sectional view, for example in production thereof.

The method may be configured as described for the energy storage cell 500, with the difference that, alternatively or in addition to the protective layer 304 on the foil 302, a protective layer 304 is provided on the solid particles. The protective material 304 may provide, for example, a sheath on the solid particles (also referred to as passivated solid particles 516).

The forming of a cathode 1022 may, in various embodiments, include: providing a foil 302; coating the foil with an alkaline slurry 514 including a solvent 506 and a multitude of solid particles including a useful layer material 1022a, 1024, 1025. The solid particles may have been coated or may be coated with a protective material 304 formed from the gas phase (also referred to as passivated solid particles 516).

For example, the coating of the active material (for example of the active cathode material) with the protective material 304 may inhibit leaching, for example of lithium, out of the lithium-containing active material. As a result, the increase in pH of the slurry 514 that contributes to corrosion of the aluminum foil may have been reduced or may be reduced. To a lesser degree, this may nevertheless be caused by other constituents of the slurry 514 (for example of the conductive additive 1025 and/or of the binder 1024).

The protective layer 304 of the passivated solid particles 516 may have been configured, for example, to inhibit the leaching of lithium out of the active cathode material 1022a.

It is optionally possible for both the foil 302 and the solid particles to have been coated or to be coated with the protective material 304. In other words, these may have been passivated or be passivated by means of the protective material 304. Alternatively, the protective material 304 of the passivated foil 512 (also referred to as first protective material 304) may be different than the protective material 304 of the passivated solid particles 516 (also referred to as second protective material 304). For example, the second protective material 304 may have a greater degree of hydrophilicity than the first protective material 304.

There follows a description of various examples that relate to what has been described above and is shown in the figures.

Example 1 is an energy storage having: an anode and a cathode, said anode having: an active anode material and/or an active anode material layer having a first chemical (e.g. electrochemical) potential; said cathode having: a foil including aluminum; an active cathode material and/or an active cathode material layer including lithium (e.g. Li/Li+), wherein the active cathode material or the active cathode material layer has a second chemical (e.g. electrochemical) potential different than the first chemical potential; a protective material which is formed from the gas phase and separates the active cathode material layer and/or the active cathode material from the foil in a fluid-tight manner, wherein, for example, the protective material has greater chemical stability to an alkaline environment than aluminum oxide; wherein, for example, the active anode material layer includes the active anode material; wherein, for example, the active cathode material layer includes the active cathode material.

Example 2 is the energy storage according to example 1, wherein a pH of the alkaline environment in which the chemical stability changes to chemical breakdown is greater for the protective material than for aluminum oxide or for aluminum.

Example 3 is the energy storage according to example 1 or 2, wherein the protective material has a lower tendency to absorb hydrogen cations than aluminum oxide or aluminum.

Example 4 is the energy storage according to any of examples 1 to 3, wherein a pH of the alkaline environment is greater than about 8, for example than about 8.5, for example than about 9, for example than about 9.5, for example than about 10.

Example 5 is the energy storage according to any of examples 1 to 4, wherein a pH of the alkaline environment in which a chemical reaction with the alkaline environment sets in is greater for the protective material than for aluminum oxide or aluminum.

Example 6 is the energy storage according to any of examples 1 to 5, wherein the protective material has a larger pH stability window than aluminum oxide or aluminum.

Example 7 is the energy storage according to any of examples 1 to 6, wherein the protective material is in physical contact with the active cathode material or the active cathode material layer; and/or wherein the protective material is in physical contact with the aluminum.

Example 8 is the energy storage according to any of examples 1 to 7, also including: an electrolyte including lithium (e.g. Li/Li+).

Example 9 is the energy storage according to any of examples 1 to 8, wherein the energy storage is an energy storage of the rechargeable type; and/or wherein the energy storage is an accumulator.

Example 10 is the energy storage according to any of examples 1 to 9, wherein an extent of the protective material (e.g. layer thickness) with which the foil has been coated for example is less than a parallel extent of the active cathode material or of the active cathode material layer.

Example 11 is the energy storage according to any of examples 1 to 10, wherein the alkaline environment includes a polar and/or protic solvent (e.g. water or an alcohol) and/or lithium.

Example 12 is the energy storage according to any of examples 1 to 11, wherein the active cathode material layer or the active cathode material includes or has been formed from lithium-iron phosphate.

Example 13 is the energy storage according to any of examples 1 to 12, wherein the active cathode material layer or the active cathode material includes or has been formed from lithium-nickel-manganese-cobalt oxide.

Example 14 is the energy storage according to any of examples 1 to 13, wherein the alkaline environment is a liquid alkaline environment and/or is provided by means of a viscous (e.g. heterogeneous) mixture, wherein the mixture includes, for example, the active cathode material, optionally one or more than one binder material, optionally one or more than one conductive additive and/or a polar and/or protic solvent.

Example 15 is the energy storage according to example 14, wherein the solvent includes or has been formed from water, an organic chemical compound of the alcohol type and/or a solution of two or more protic solvents; where, for example, the mixture consists to an extent of more than about 50% by volume (percent by volume), for example than 60% by volume (for example than 75% by volume), of the protic solvent.

Example 16 is the energy storage according to any of examples 1 to 15, wherein the foil has been coated with the protective material.

Example 17 is the energy storage according to any of examples 1 to 16, further including: a multitude of solid particles that include the active cathode material and have been coated (for example encased in a fluid-tight manner) with the protective material.

Example 18 is the energy storage according to any of examples 1 to 17, wherein the protective material is a metallic material.

Example 19 is the energy storage according to any of examples 1 to 18, wherein the active anode material layer is porous and/or the active anode material is granular; and/or wherein the active cathode material layer is porous and/or the active cathode material is granular; and/or wherein the active anode material and/or the active cathode material are lithiatable.

Example 20 is the energy storage according to any of examples 1 to 19, wherein the active anode material layer and/or the active cathode material layer has a greater porosity than the protective material (for example the layer formed therefrom) and/or than the foil; and/or wherein the active cathode material and/or the active anode material has a greater degree of granularity (ratio of surface area to volume of substance) than the protective material.

Example 21 is the energy storage according to any of examples 1 to 20, wherein the protective material provides a layer (also referred to as protective layer) that separates the active anode material layer or the active anode material and the foil from one another in a fluid-tight and/or ion-tight manner.

Example 22 is the energy storage according to any of examples 1 to 21, further including: an encapsulation that surrounds the anode and the cathode and/or has a cavity in which the anode and the cathode are disposed.

Example 23 is the energy storage according to any of examples 1 to 22, further including: a first exposed contact connection that contacts the anode and/or a second exposed contact connection that contacts the cathode.

Example 24 is the energy storage according to any of examples 1 to 23, wherein the foil has been coated with the protective material on both sides, for example has a coating of the protective material on both sides.

Example 25 is the energy storage according to any of examples 1 to 24, wherein the first electrochemical potential, with respect to lithium (e.g. Li/Li+, i.e. with lithium as reference), has a voltage of less than about 1.2 V (for example than about 1 V, for example than about 0.8 V, for example than about 0.5 V, for example than about 0.3 V, for example than about 0.1 V).

Example 26 is the energy storage according to any of examples 1 to 25, wherein the second electrochemical potential, with respect to lithium (e.g. Li/Li+, i.e. with lithium as reference), has a voltage of greater than about 3.0 V (for example than about 3.5 V, for example than about 4 V) and/or less than or equal to 4.3 V.

Example 27 is the energy storage according to any of examples 1 to 26, wherein an electrochemical potential difference between the cathode and the anode is greater than about 3.0 V (for example than about 4 V, than about 4.2 V) and/or less than 4.3 V.

Example 28 is the energy storage according to any of examples 1 to 27, further including: a separator which is disposed between the anode (for example the active anode material layer thereof or active anode material thereof) and the cathode (for example the active cathode material layer thereof or active cathode material thereof), for example insulates (for example electrically separates) these from one another, wherein the separator is ion-conductive for example and/or is penetrated by the (for example lithium ion-conductive) electrolyte, wherein, for example, the separator has a greater ion conductivity than the protective material (or than the protective layer).

Example 29 is the energy storage according to any of examples 1 to 28, wherein the foil includes a laminate or composite material.

Example 30 is the energy storage according to any of examples 1 to 29, wherein the foil is a metal foil.

Example 31 is the energy storage according to any of examples 1 to 30, wherein the foil has a carrier (for example in ribbon form) made of a polymer.

Example 32 is the energy storage according to any of examples 1 to 31, wherein the foil is thinner than 40 μm (for example than 20 μm).

Example 33 is the energy storage according to any of examples 1 to 32, wherein the protective material includes copper (e.g. a copper layer), wherein the protective material has, for example, multiple layers that differ in terms of their chemical composition, and one layer of which is the copper layer.

Example 34 is the energy storage according to any of examples 1 to 33, wherein the protective material includes titanium (e.g. a titanium layer), wherein the protective material has, for example, multiple layers that differ in terms of their chemical composition, and one layer of which is the titanium layer.

Example 35 is the energy storage according to any of examples 1 to 34, wherein the protective material includes nickel (e.g. a nickel layer), wherein the protective material has, for example, multiple layers that differ in terms of their chemical composition, and one layer of which is the nickel layer.

Example 36 is the energy storage according to any of examples 1 to 35, wherein the protective material includes carbon (e.g. a carbon layer), for example above the copper layer, wherein the protective material has, for example, multiple layers that differ in terms of their chemical composition, and one layer of which is the carbon layer.

Example 37 is the energy storage according to any of examples 1 to 36, wherein the carbon is in a carbon modification.

Example 38 is the energy storage according to any of examples 1 to 37, wherein the carbon modification includes or has been formed from graphene; and/or wherein the carbon modification includes or has been formed from amorphous carbon.

Example 39 is the energy storage according to any of examples 1 to 38, wherein the protective material is free of aluminum.

Example 40 is the energy storage according to any of examples 1 to 39, wherein the protective material has a hydrophilic surface (for example on the opposite side from the foil), for example the energy storage further including: a hydrophilic material with which the protective material has been coated.

Example 41 is the energy storage according to example 40, wherein the hydrophilic material has a greater degree of hydrophilicity than the protective material.

Example 42 is the energy storage according to example 41, wherein the protective material is hydrophobic.

Example 43 is the energy storage according to any of examples 1 to 42, wherein an extent of the protective material is less than a parallel extent of the active cathode material or of the active cathode material layer.

Example 44 is the energy storage according to any of examples 1 to 43, wherein the protective material provides a layer having a layer thickness of less than 1 μm (micrometer), for example less than 0.5 μm, for example less than 0.2 μm, for example less than 0.1 μm.

Example 45a is the energy storage according to any of examples 1 to 44, wherein the protective material is hydrophobic and/or has a surface which is hydrophobic.

Example 45b is the energy storage according to any of examples 1 to 44a, wherein a degree of hydrophilicity of the (for example hydrophobic) protective material is increased by means of processing of the protective material, for example by means of an aftertreatment (for example by means of one or more than one flashlamp) such that it has a greater degree of hydrophilicity thereafter.

Example 45c is the energy storage according to any of examples 1 to 44b, wherein the protective material has been provided in a first configuration and a second configuration, wherein the second configuration is separated (for example in a fluid-tight manner and/or spatially) from the active cathode material layer or the active cathode material by means of the first configuration, and wherein the first configuration has a greater degree of hydrophilicity than the second configuration, wherein, for example, the first configuration has the surface which is hydrophobic.

Example 45d is the energy storage according to any of examples 1 to 44c, wherein the protective material (for example in the first configuration) has a greater degree of hydrophilicity than the foil, aluminum and/or aluminum oxide.

Example 46 is a method of forming an energy storage according to any of examples 1 to 45, said method including: optionally providing a (for example viscous and/or alkaline) mixture including, for example, the active cathode material and/or a polar and/or protic solvent; optionally providing the foil including the aluminum; coating the foil with the viscous and/or alkaline mixture (for example a slurry) including the active cathode material; extracting the solvent from the mixture with which the foil has been coated to form a solid layer including the active cathode material.

Example 47 is the method according to example 46, wherein the providing of the foil includes: coating the foil with the protective material by means of a gas phase deposition (also referred as to vapor deposition), for example a physical gas phase deposition.

Example 48 is the method according to example 46 or 47, wherein the alkaline mixture (for example a slurry) includes a multitude of solid particles (for example a colloid).

Example 49 is the method according to example 48, wherein the solid particles include or have been formed from the active cathode material.

Example 50 is the method according to example 49, wherein the solid particles have been coated, for example encased and/or fluid-sealed (encased in a fluid-tight manner) by means of the protective material.

Example 51 is the method according to any of examples 48 to 50, further including: coating the multitude of solid particles that include the active cathode material with the protective material by means of a gas phase deposition, for example a physical gas phase deposition.

Example 52 is the method according to any of examples 48 to 51, wherein the alkaline mixture (for example the slurry) includes a solvent and/or lithium.

Example 53 is a method of coating a substrate (for example a foil) including aluminum, said method including: providing the substrate (for example the foil) and/or a granular useful layer material that has been coated with a protective material from the gas phase; coating the substrate (for example that which has been coated with the protective material) with a (for example viscous and/or alkaline) mixture (for example a slurry) including a solvent and the useful layer material (for example that coated with the protective material); extracting the solvent from the mixture (for example the slurry) with which the substrate has been coated to form a solid (for example porous) layer including the useful layer material, wherein the useful layer material includes lithium for example; the providing including for example: coating the substrate (for example the foil) and/or the granular useful layer material with the protective material by means of a gas phase deposition, for example a physical and/or chemical gas phase deposition.

Example 54 is the method according to example 52 or 53, wherein the solvent is a polar and/or protic solvent (e.g. water or an alcohol); and/or wherein the useful layer material includes lithium.

Example 55 is the method according to any of examples 52 to 54, wherein the solvent includes or has been formed from water, or wherein the solvent includes or has been formed from alcohol (e.g. ethanol or isopropanol).

Example 56 is the method according to any of examples 46 to 55, wherein the useful layer material includes an organic binder (e.g. adhesive).

Example 57 is the method according to any of examples 53 to 56, wherein the useful layer material includes or has been formed from an active cathode material, wherein the useful layer material optionally includes or has been formed from a conductive additive material.

Example 58 is the method according to any of examples 53 to 57, wherein the useful layer material is granular, and, for example, wherein the granular useful layer material includes a multitude of solid particles (for example including or formed from the active cathode material) which have been coated by means of the protective material for example, for example encased and/or fluid-sealed (encased in a fluid-tight manner).

Example 59 is the method according to any of examples 53 to 58, wherein the protective material separates the useful layer material from the mixture in a fluid-tight manner; and/or wherein the protective material separates the substrate from the mixture in a fluid-tight manner.

Example 60 is the method according to any of examples 53 to 59, wherein the substrate includes or has been formed from a foil.

Example 61 is the method according to any of examples 53 to 60, wherein the gas phase deposition is a physical gas phase deposition (for example including thermal evaporation) or a chemical gas phase deposition.

Example 62 is the method according to any of examples 46 to 61, wherein the coating with the viscous and/or alkaline mixture is effected by means of a comma bar (e.g., a doctor blade).

Example 63 is the method according to any of examples 46 to 62, wherein the mixture includes N-methyl-2-pyrrolidone, or wherein the mixture is free of N-methyl-2-pyrrolidone.

Example 64 is the method according to any of examples 46 to 63, wherein the coating with the mixture is effected in an atmospheric environment (for example in the Earth's atmosphere); and/or wherein the coating is effected in an atmosphere having a relative air humidity of more than about 30% (for example 50% or 75%).

Example 64 is the method according to any of examples 46 to 63, wherein the protective material has a greater chemical stability toward the mixture than aluminum oxide.

What is claimed is:

1. A method of forming an energy storage, said energy storage having:
an anode and a cathode,
said anode having:
an active anode material having a first chemical potential;
said cathode having:
a foil including aluminum;
an active cathode material including lithium,
wherein the active cathode material has a second chemical potential different than the first chemical potential;
a protective material which is formed from the gas phase and separates the active cathode material from the foil in a fluid-tight manner,
said method comprising:
coating the foil with a mixture including the active cathode material and a protic solvent;
extracting the solvent from the mixture with which the foil has been coated to form a solid layer including the active cathode material.

2. The method as claimed in claim 1,
wherein the protective material has a greater chemical stability to an alkaline environment than aluminum oxide.

3. The method as claimed in claim 1,
wherein a pH of the mixture at which a chemical reaction with the mixture sets in is greater for the protective material than for aluminum oxide.

4. The method as claimed in claim 1,
wherein a pH of the mixture is greater than about 8.

5. The method as claimed in claim 1,
wherein the solvent is water.

6. The method as claimed in claim 1,
wherein the solvent comprises an organic chemical compound of the alcohol type.

7. The method as claimed in claim 1,
wherein the foil has been coated with the protective material.

8. The method as claimed in claim 1, further including:
a multitude of solid particles that comprise the active cathode material and have been coated with the protective material.

9. The method as claimed in claim 1,
wherein the protective material comprises copper.

10. The method as claimed in claim 1,
wherein the protective material comprises titanium.

11. The method as claimed in claim 1,
wherein the protective material comprises nickel.

12. The method as claimed in claim 1,
wherein the protective material comprises carbon.

13. The method as claimed in claim 1,
wherein the protective material has a hydrophilic surface.

14. A method of coating a substrate including aluminum, said method comprising:
providing the substrate that has been coated with a protective material from the gas phase;
coating the substrate that has been coated with the protective material with an alkaline mixture including a solvent and a useful layer material;
extracting the solvent from the alkaline mixture with which the substrate has been coated to form a solid layer including the useful layer material.

15. The method as claimed in claim 14, wherein the providing comprises a coating with the protective material by means of a gas phase deposition.

16. A method of coating a substrate including aluminum, said method comprising:
providing a granular useful layer material that comprises lithium and has been coated from the gas phase with a protective material;
coating the substrate with a mixture including a protic solvent and the useful layer material that has been coated with the protective material;
extracting the solvent from the mixture with which the substrate has been coated to form a solid layer including the useful layer material.

17. The method as claimed in claim 16, wherein the providing comprises a coating with the protective material by means of a gas phase deposition.
